(19) United States
(12) Patent Application Publication
(10) Pub. No.: US 2006/0161447 A1
(43) Pub. Date: Jul. 20, 2006

(54) Strategic occupancy planning

(76) Inventors: Kristine O'Hollearn, San Diego, CA (US); Joe O'Hollearn, San Diego, CA (US)

Correspondence Address: GORDON & REES LLP, 101 WEST BROADWAY, SUITE 1600, SAN DIEGO, CA, 92101, US

(21) Appl. No.: 11/039,739

(22) Filed: Jan. 19, 2005

(51) Int. Cl. G06Q 99/00

(52) U.S. Cl. 705/1

(57) ABSTRACT

The present invention relates to a computerized space programming method. In the method five critical phases are utilized to determine the optimal space programming for a business. These phases are (1) validation phase, to get an accurate snapshot of the current space, (2) forecasting phase, interpreting the future, (3) adjacency phase, determining the critical relationships between departments, (4) questionnaire phase, interviewing the management to determine what is important to the business; and (5) analysis phase, generates reports in order to after analyze all the data.

### FIELD OF THE INVENTION

The present invention relates to capturing the qualitative and quantitative issues affecting a business' current and future space needs utilizing a computer program.

### BACKGROUND OF THE INVENTION

Needs assessment or space programming determines how much space is available for a business, such as a company or an organization (hereinafter referred to as “business”). This is then compared with the amount of space required by each of the various departments of the business. Traditionally, space programming has required paper-intensive efforts that have often become popularity contests of where to locate people and departments instead of focusing on true organizational effectiveness. Due to all the information or data that needs to be gathered, space programming is extremely time intensive and complicated.

Space programming involves assessing all requests for space using particular guidelines, determining the space requirement needs of users and creating space solutions for the needs of businesses. Furthermore, it is an information gathering and forecasting effort utilized by businesses that value their environment as an important factor for productivity, creativity and efficiency. Whether the need is new office facilities, refurbishment of existing space, identification of how long present facilities will meet space requirements (space audit) or management of space constraints, space programming provides the data that drives the recommendations and strategies of facilities departments.

As described above, current space programming methods are paper intensive and have revolved around popularity contests. Due to all the information or data that needs to be gathered during space programming, a method is needed where all the information gathered is computerized and the data is analyzed objectively creating various strategic options that are available to the business.

### SUMMARY OF THE INVENTION

It is an object of the present invention to streamline the information gathering phase of space programming.

It is a further object of the present invention to validate current assets and forecast future needs for each of a business' departments.

It is yet a further object of the present invention to plan or develop space or occupancy programming of a business taking into consideration short-term and long-term requirements.

It is yet a further object of the present invention to make the process of space programming more cost effective by expediting the space programming of a business and more accurately predicting a business' space needs.

It is yet another object of the present invention to fill out an online survey regarding the qualitative business, regulatory or political issues that affect the business' future needs.

It is yet another object of the present invention to print or view detailed reports of the forecast of the space programming.

It is yet another object of the present invention to sort, validate, summarize and analyze a business' space-related data.

It is yet another object of the present invention to make recommendations with accurate information in a short time frame without talking to many people, just key players.

In the present invention, a method is described for optimizing strategic occupancy programming of a business. The space programming of the present invention assists businesses with the strategic dilemmas they face in facilities management. These dilemmas include:
How do we make our existing facilities last two more years?
We merged with/acquired another company. How do we transition them into our current buildings?
One of our leases is expiring. Can we manage without the space?
How much more efficient would we be with a space standards program?
We are out of space. What are our options? What are the costs of each option?
We need to get a better handle on our future space requirements. Can you develop a five-year plan?
We would like to forecast square footage requirements to our build out year of 2017 and determine appropriate occupants for our buildings.
If we were to think of another campus in a new city, who might be candidates for that space?
We just had layoffs and have too much real estate—Which buildings should we get rid of?

In a preferred embodiment of the present invention, there are six critical phases to the computerized method. The first phase, the validation phase, beings the process of space programming by getting an accurate snapshot of the current space so that a realistic forecast can be obtained. The second phase, the forecasting phase, involves gathering all the critical facts. Facts are gathered in many different ways, including, but not limited to, reviewing the business plan, analyzing the site or location, reviewing office standards, observing the workers and conducting interviews of employees of the business. Once all the facts have been gathered, the planners can begin the third phase of the strategic occupancy programming which are project goals/directions, or the adjacency phase. During the adjacency phase, relationships between departments are identified. This phase determines which departments should be located next to each other, which departments should be on the same floor and which departments should be located on the same site and the reason for each location. In the preferred embodiment of the present invention, any conflicts are identified and the number of options of where a department can be located is restricted to expedite the space programming and to provide a cost effective method of space programming. Next, during the interview phase, the executives or management of the business are interviewed to determine what is important and what direction the business is moving towards. Furthermore, any assumptions that have been made are challenged and buffer space is included for unforeseen circumstances. Once the adjacencies, forecasting phases and interview phases have been approved, the programming moves onto the fifth phase, the analysis phase. The data gathered is analyzed by looking at databases of information, comparing the gathered data to previous data, researching and looking at industry benchmarks. Finally, after all the data has been analyzed, the final phase of the programming occurs, that phase being what the strategic options, or the feasibility studies, are. When looking at the options, the planners look at the definitions, the budget, the advantages and disadvantages of each option and the schedule or time line involved in implementing each of the various options.

The foregoing, together with other features and advantages of the present invention, will become more apparent when referring to the following specification, claims and accompanying drawings.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1 illustrates a detailed report summarizing the growth of departments in a business by square footage;

FIG. 2 illustrates a detailed report summarizing department growth by headcount;

FIG. 3 illustrates an example of a forecasting screen showing the people and spaces in a department right now and how they intend to grow or shrink, generated by the method of the present invention;

FIG. 4 illustrates an example of a human resource database of a business uploaded to the computerized space programming system showing the real-time view of employees in a department of the business; FIG. 5 illustrates a screen shot from the computerized method of the present invention that allows the user to add new support space, such as conference rooms, files and labs;

FIG. 6 illustrates an example of a square footage report generated by the method of the present invention;

FIG. 7 illustrates an example of a matrix generated in the adjacency phase, which displays the critical departments, which need to be adjacent to each other and for what reason;

FIG. 8 illustrates an example of a portion of a web questionnaire, to be reviewed in the interview, generated by the method of the present invention; and

FIG. 9 illustrates a flow diagram of the forecasting portion of the method of the present invention.

### DETAILED DESCRIPTION OF THE DRAWINGS

In the present invention, a computerized method is described for optimizing strategic occupancy planning or space programming/forecasting of a business. In a preferred embodiment, there are six critical phases to the method: validation phase, forecasting phase, adjacencies phase, interview phase, analysis phase and strategic options phase. In the preferred embodiment, the validation phase begins the process of space programming. During this phase, an accurate snapshot of the current space is obtained so that a realistic forecast can be obtained by entering this data into a computer. The accurate snapshot includes a real-time view of the employees in each department and where the business says they are located. This information can be obtained by uploading a database of information, such as a human resource database, to the computerized space planning program. Once this information is obtained, the business must then determine if this is accurate employee information, transfer employees into and out of particular departments, remove employees who have left the business, add new employees, consultants or temps who require space and view sample office standards and confirm assignments to each employee.

In addition to employee information, support spaces are entered into the computer as they are are a critical ingredient for each department. In the validation phase, support spaces are confirmed, i.e., labs, file rooms, printer areas, etc. that are currently occupied. There is no need to guess as the present invention allows the user to choose, from a pull down menu on a computer screen, the real spaces that are occupied by site, building, floor and room number utilizing forms from the computerized space programming system. Square footage is already assigned from floor plans. The validation phase also allows the user to transfer support spaces in or out of a department to get an accurate view of the current square footage, modify existing spaces by enlarging, decreasing or combining spaces, and add new spaces or spaces that the user has or will need in the future and indicate special needs for specific rooms. The present invention also allows an administrative assistant or additional users to perform the validation part of the process for each of the departments so that the management will only have to complete the strategic information in the forecast, adjacency and interview phases. The administrative assistant can be given a different login allowing the assistant to only validate information in the departments and not to view forecast, interview or adjacency information, which may be sensitive or confidential. This saves time for the manager. If the employees are being moved around and if a department takes an employee from another department, the manager from the department losing an employee is notified and must agree to the relocation of the employee.

After the user completes the validation phase, the user proceeds to the next phase which is the forecasting phase. The forecasting phase is used to identify how the department will change over the next 1, 2, 5, 10 years etc. This phase involves gathering all the critical facts associated with the occupancy or space programming directly from department managers and directors who usually know best; how and why their organization is going to grow. Examples of facts to be gathered include, but are not limited to, the number of current employees, the names, titles and positions of the current employees, the location of the current employees, the current square footage of the current employees' work space, support areas needed by the current employees, the required square footage need of the current employees workspace, etc. Facts can be gathered in many different ways, including, but not limited to, reviewing the business plan, analyzing past history and observing the workers. With the present invention, department managers' forecasts go straight from their desktop to facilities reports. Furthermore, forecast growth or reduction can be done by position, including adding new positions with no current headcount; current headcount by position can be determined based on validated employee detail, or “what's on the ground now”; and positions are tied to actual office standards (typicals) and square footage.

In the preferred embodiment, the forecasting phase involves a four-step process, which includes: (1) validating the current employees for a department; (2) projecting headcount growth; (3) validating current support spaces for a department; and (4) projecting future growth space. Validation allows the verification of current employees and support spaces that belong to a particular department. Current relates to the people and spaces in a particular department right now, not at some time in the future. In other words, it is a snapshot of current conditions at the site, and does not indicate TBHs (to be hired), Future, or Open positions. Projecting growth is where the Future, Open or TBH positions and additional support needs are indicated.

The forecasting phase begins by selecting a department from a scroll box located on the computer screen or a functional areas/department drop down menu on the computer screen. The computerized program tracks the departments for which there is a completed forecast, for those where a forecast has not been started and for those where a forecast has been started, but not yet completed. Examples of departments can include human resources, service administration, technical sales support, software consulting, customer care, engineering, pharmacy consulting, etc. The types of departments or groups depend upon the type of business for which the strategic occupancy programming is being utilized. Each department contains at least one employee and once the department is selected, facts regarding each of the employees are displayed. Typical facts about each employee are described above. At this point, information or facts about the employees can be modified including their job title and where they are seated or located. Prior to moving to the personal growth forecasting section for a department, the management or other personnel of the business must indicate that the data is correct by selecting an accept button (not shown). Once the data has been accepted, the management is provided the opportunity to review any positions with zero current headcount, but projected growth. If the business no longer needs that position at any time in the future, that position can be removed from the system. In addition to removing positions, new positions or job titles can be added. This can be accomplished by selecting a position from a drop down menu and then selecting an add button.

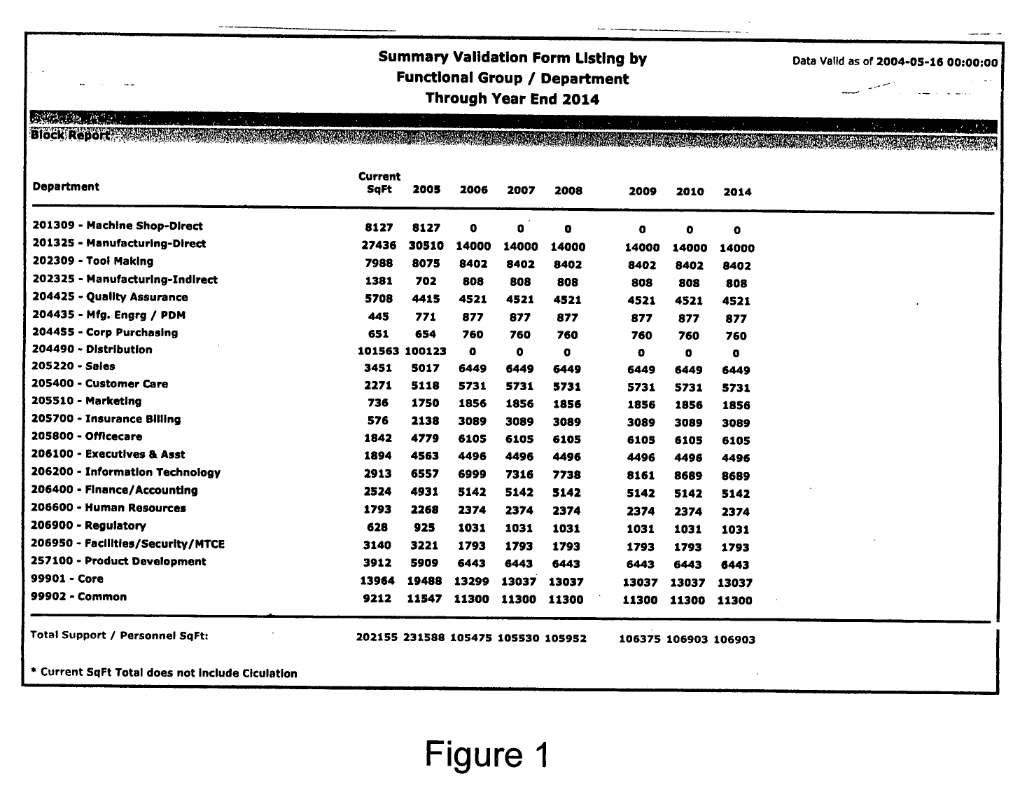

Turning to FIG. 1, a detailed report summarizing growth of departments by square footage obtained by completing the forecasting phase is illustrated. In this report, 22 departments are listed and the current square footage each department is currently using. This report also illustrates how each of the department's square footage is anticipated to grow or shrink for fiscal years 2005, 2006, 2007, 2008, 2009, 2010 and 2014. Viewing this report allows the business to compare the current space with the space that will be needed in the future to determine if more square footage will be required. The departments listed are by way of example only and any type of department can be summarized similarly.

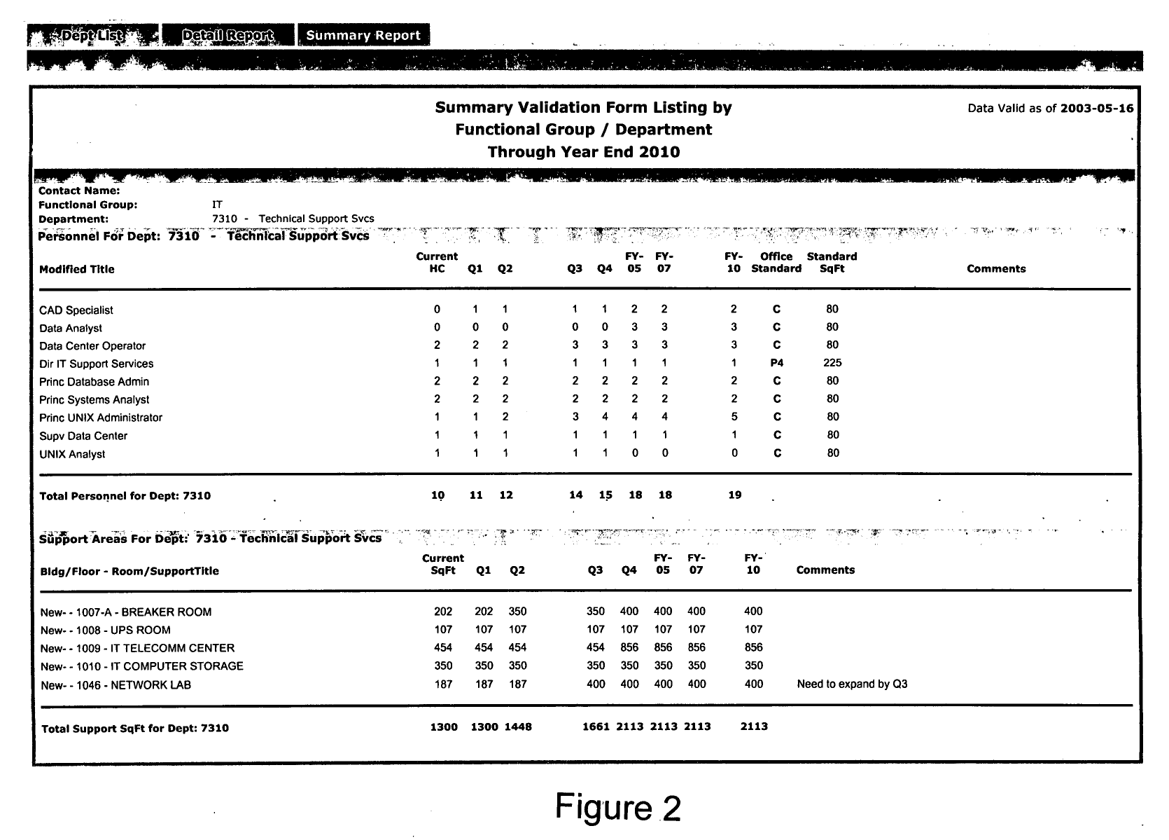

FIG. 2 illustrates a detailed report summarizing growth of a single department (technical services in this case) by headcount obtained by completing the forecasting phase. This report is divided into two areas, the personnel for the technical support services and the support areas for the technical support services. In the personnel section, 9 positions are listed along with the current number of people that hold that position. This portion of the detailed report also illustrates how the department is expected to grow for all four quarters of 2004 as well as fiscal years 2005, 2007 and 2010 and the associated square footage that will be needed for the department. The detailed report also has a space for the user to add any comments. If future growth in a department is anticipated, the user can forecast the headcount growth for a position by indicating the new headcount numbers. Once the new headcount numbers are indicated, the user reviews the employee growth information and indicates the data is correct and moves to the support section for the particular department. In the support section, the user is allowed to enter new support space that the department will need.

In the support area section, 5 support areas for the department are listed along with the current square and how each of the support area's square footage is anticipated to grow or shrink for fiscal years 2005, 2007 and 2010. Viewing this report allows businesses to compare the current number of employees in a department with the projected number of employees needed in the department over the next several years. It should be noted that this report on the technical support services department is by way of example only and all departments of the business can be summarized similarly.

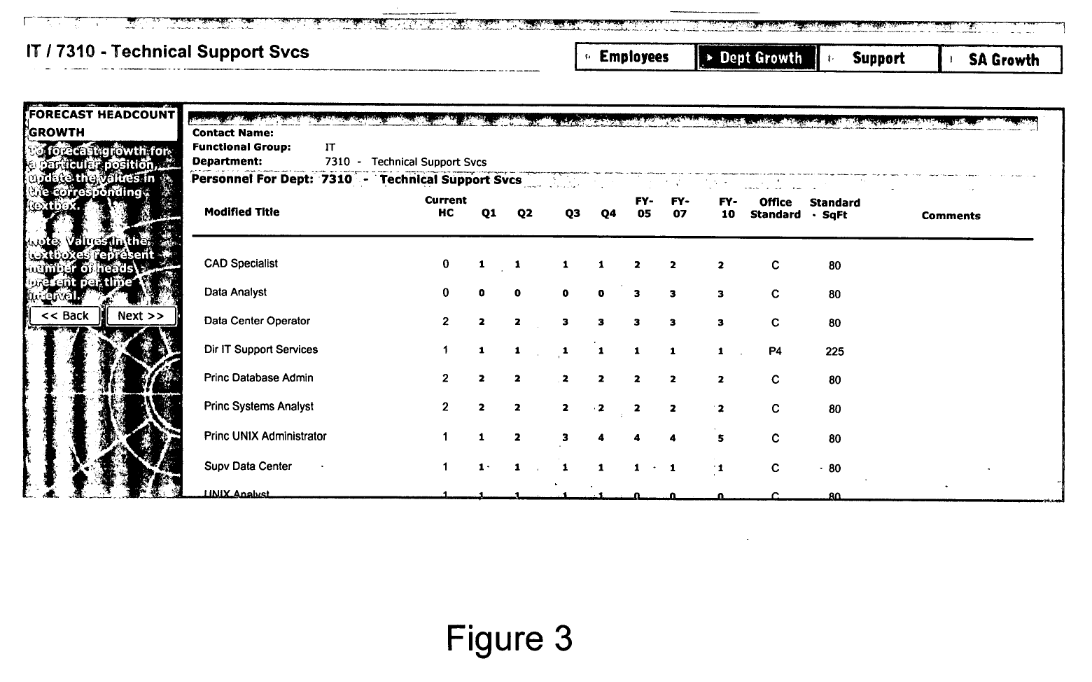

FIG. 3 illustrates an example of a forecasting screen of the computerized program of the present invention that allows the user to enter information on projected headcount growth of a department. In the example shown in FIG. 3, positions of the technical support services department are listed along with the current number of people that hold that position. When the user is done entering the information on how the business is anticipated to grow for all four quarters of 2004 as well as fiscal years 2005, 2007 and 2010 and the associated square footage, the user selects a next button and enters information for another department. The forecasting sheet also has a space for the user to add any comments. This report is by way of example only and all departments can be summarized in the same way.

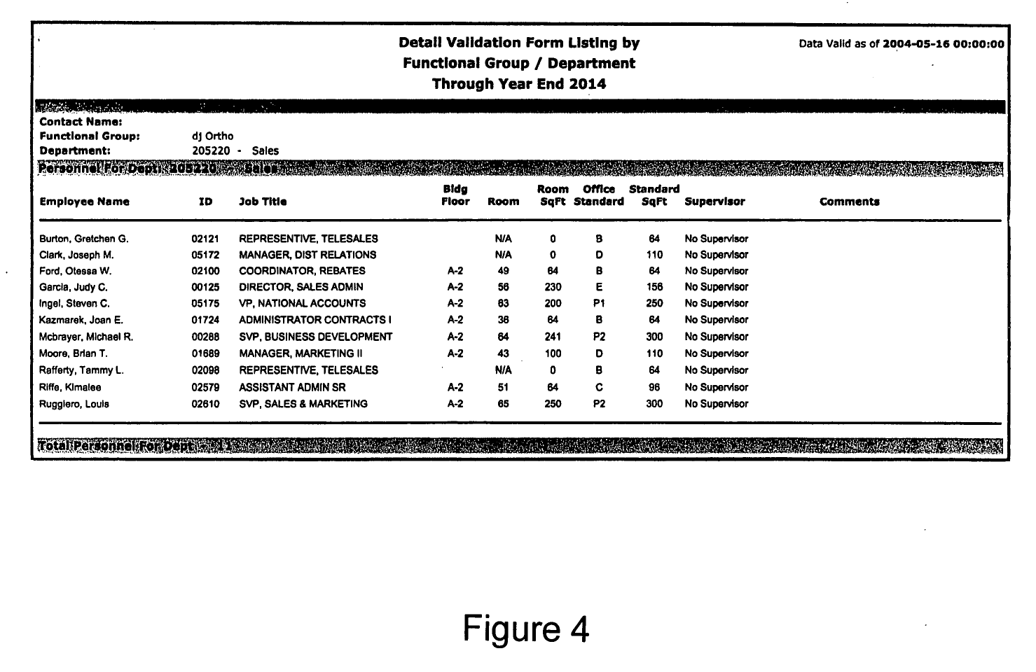

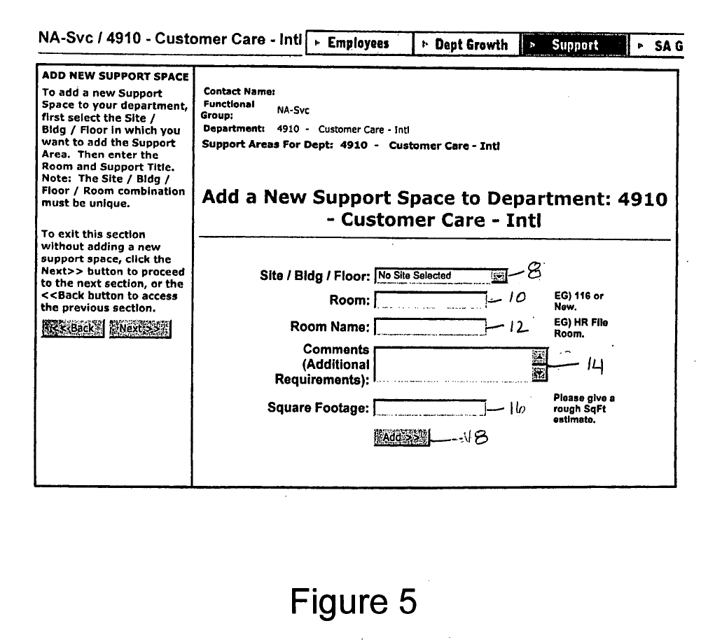

FIG. 4 illustrates an example of a human resource database of a business uploaded to the computerized space programming system showing the real-time view of employees in a department of the business obtained during the validation phase. This database is by way of example only and various other databases from the business can be uploaded. In this example, there are currently 11 employees listed. Along with their name, also listed is their position in the business, their location in the building, the current square footage of their location or office as well as the standard square footage, their supervisor name, if any, and any comments that management may want enter about each employee. Once this information has been entered by a user, typically the management of the business, the user reviews the information and can either accept the information as accurate or correct any information that is incorrect. If the information is not correct, the user can add or delete information as is necessary. Specifically, the user can correct employee information, easily transfer employees into and out of a department with a few clicks, remove employees who have left the company, add new employees, consultants or temps who require space and view samples of office standards to confirm employee assignment.

FIG. 5 illustrates an example of a screen shot from the computerized method of the present invention. This particular screen shot allows the user to add new support space. First the user selects the site/building/floor 8 in which the user wants to add the support area. Next the user is prompted to enter in the selected spaces the room 10, room name 12, any comments 14 and the square footage of the room 16. Once all the new support areas have been selected, the user selects an add button 18 and moves on to the Adjacencies phase. Similar screen shots are used to enter additional information.

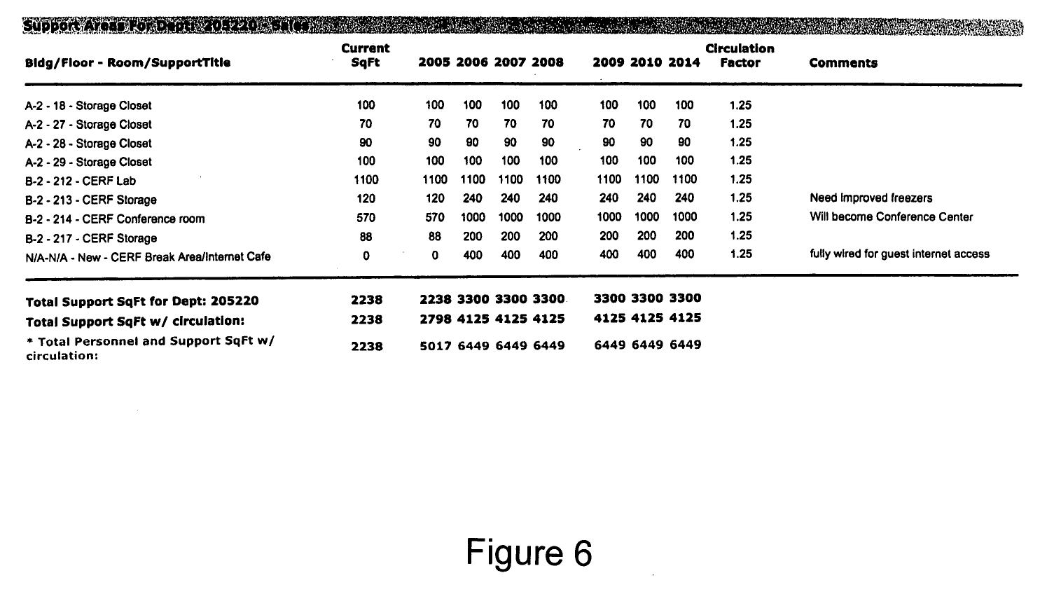

FIG. 6 illustrates an example of a square footage detailed report generated showing the square footage needs of support areas of a business. Other detailed reports can include a site summary; a site/business unit summary; a site/business unit/department summary; site/business unit/department detail; and vendors contractors and temps. In this particular report, 9 support areas are listed along with the current square footage needed for each support area and how each of the support area's square footage is anticipated to grow or shrink for fiscal years 2005, 2007 and 2010. The detailed report also has a space for the user to add any comments, such as improved freezers are needed, a specific support area will become a conference center and that a specific support area is wired for guest internet access.

An adjacency is the physical location of the department in relationship to other departments or support spaces. In order to make the business most effective, the business must prioritize the departments and spaces whose physical location is most critical to the departments' success. For example, in some businesses, quality assurance should be next door to production, or sales should be on the same floor as marketing, or security should be next door to the lobby. Traditionally adjacency exercises are paper-intensive efforts that often become popularity contests instead of focusing on true organizational effectiveness. With the present invention, these efforts can be turned into a rigorous up-front planning tool. The Adjacencies phase is a three (3) step process: (1) Identifying the critical adjacency needs of one department to other departments; (2) Resolving any discrepancies between the stated adjacency needs and those stated by other departments; and (3) Identifying the adjacency needs of the user's department(s) to specific support spaces.

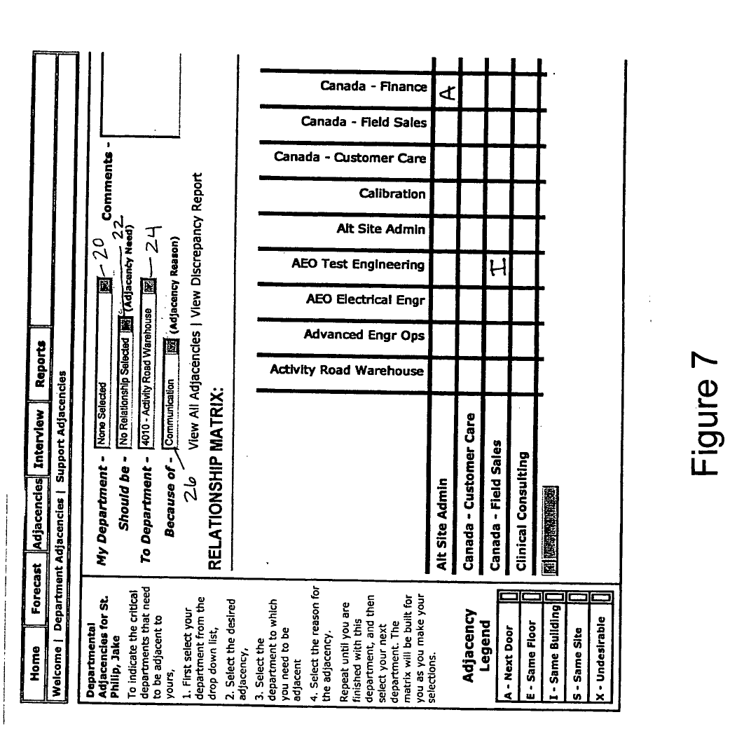

Referring to FIG. 7, to indicate the critical departments that need to be adjacent to each other, the user (1) selects a department from a drop down list 20; (2) selects the desired adjacency 22; (3) selects the department that needs to be adjacent 24; and (4) selects the reason for the adjacency 26. These four steps are repeated until the user is finished with the first selected department and then the next department is selected. A matrix, as shown in FIG. 7, illustrates the critical departments, which need to be adjacent to each other. This simple matrix format is easy to understand. The matrix builds itself based upon the management's selections. For example, finance might need to be next door to site administration or electrical engineering might need to be in the same building as field sales as is illustrated in FIG. 7. The space programming method of the present invention forces prioritization and discrepancy resolution between managers. Once the Adjacencies phase is completed, the user moves on to the Interview Phase. Messages are sent via email to departments that have conflict, for example, Marketing is next door to Sales and it is undesirable for Sales to be next door to Marketing.

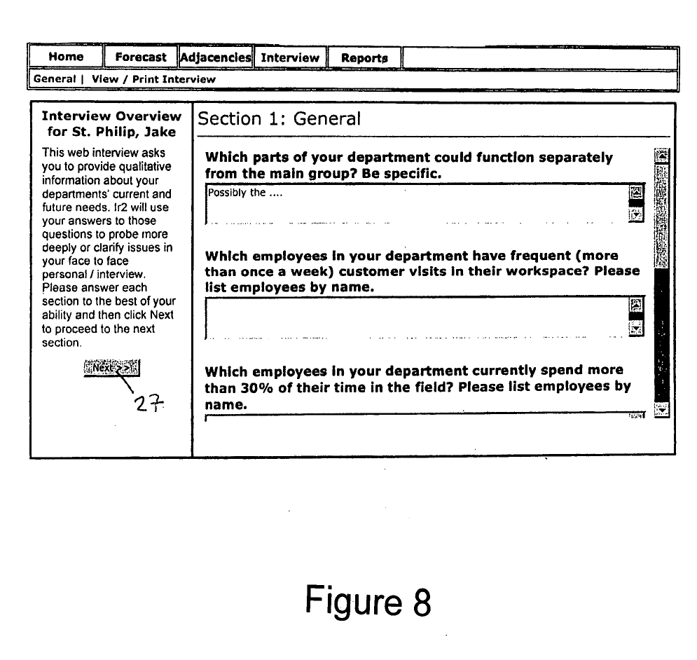

After the Adjacency Phase has been completed, the user next begins the Interview Phase. The Interview Phase is comprised of 2 sections, the web interview and the face-to-face interview. In the web interview, the user is asked to provide qualitative information about a department's current and future needs, goals and issues. In the preferred embodiment of the present invention, the answers to these questions from the web interview will be used to probe more deeply or clarify issues in the face-to-face interview. FIG. 8 illustrates an example of a portion of a web interview generated by a method of the present invention. This is accomplished by uncovering critical concerns which allows more time for probing complex issues in person, save time by holding a face-to-face interview with the management only if the management has critical or complex needs and reduces the “note-taking frenzy” ensuring more accuracy and comprehension of all issues. The management is asked to answer each question and then proceed to the next section by selecting the next button 27. The method of the present invention allows users to change responses to any of the questions and all modifications are updated real-time. Examples of some types of questions include the following:
Which parts of your department could function separately from the main group?
Which employees in your department have frequent (more than once a week) customer visits in their workspace? Please list employees by name.
Which employees in your department currently spend more than 30% of their time in the field? Please list employees by name.
Which employees in your department would be interested in a full or part-time (e.g., 3 days at home, 2 days in office) telecommuting arrangement? Consider employees who have expressed an interest in the past, or employees who currently have an excessive commute (more than 30 minutes each way). Please list employees by name.
Which temporary or contract employees in your department could share a workspace with another employee? Please list by name.

As indicated, these are just some examples of questions and the questions can be tailored to the particular situation of the business. The number of questions is also dictated by the particular situation of the business. If at any time the user desires to change the response to any of the sections, the user can do so by selecting from the various sections in the interview menu. All responses to the questions are updated real-time.

Once the validation, forecasting, adjacency and interview phases have been approved, the programming moves onto the fifth phase, the analysis phase. The data gathered is analyzed by looking at databases of information, comparing the gathered data to previous data, researching and looking at industry benchmarks. Analyzing the data allows businesses to see what the current situation is and determine what the future goals of the business are.

Once the first five critical phases of the strategic occupancy programming method of the present invention have been completed, the final phase is begun and several different reports are generated identifying the strategic options of the business. Standard reports can be produced at the push of a button ready for strategic programming, customized reports can be designed to address ongoing facility needs, and “What if” scenarios are made quick and simple to suggest a plan the business can stand behind. These reports can be based upon such things as headcount and square footage.

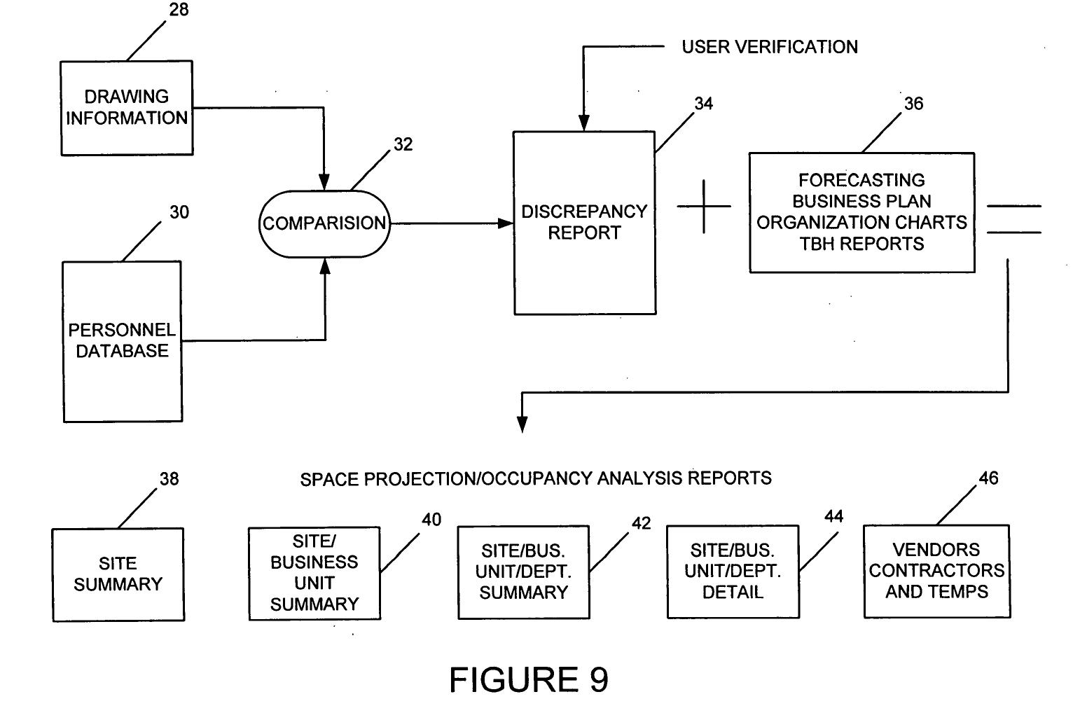

FIG. 9 illustrates a flow diagram of the forecasting phase of the method of the present invention. In the flow diagram, drawing information (floor plan) 28 of the business is compared 32 to the personnel database 30 of the business. Once compared, a discrepancy report is generated for the user's verification. The discrepancy report identifies any problems in the number of people and the amount of space they require with the floor plan. This information is then used with the forecasting information 36 (i.e. business plan, organization charts, TBH reports, etc.) to produce space projection/occupancy analysis reports. These reports can include (1) site summary 38; (2) site/business unit summary 40; (3) site/business unit/department summary 42; (4) site/business unit/department detail 44; and (5) vendors, contractors and temps 46.

Although an exemplary embodiment of the invention has been described above by way of example only, it will be understood by those skilled in the field that modifications may be made to the disclosed embodiment without departing from the scope of the invention, which is defined by the appended claims.

We claim:

1. A computerized method of space programming comprising the steps of:
determining the current space of a business by a user entering a detailed listing of current employees of the business and support spaces needed for each department in the business by filling in an online form;
forecasting future employees as well as projecting future growth space;
determining the goals of the business to determine what is important to the business and what direction the business is moving towards;
determining the location of each of the departments of the business in relation to each other;
performing an online web interview of the user to clarify issues which will be discussed in a face-to-face interview; and
utilizing all data gathered to provide analysis reports to the user.

2. The method of claim 1, further comprising the step of the user filling out an online survey regarding the qualitative business, regulatory and political issues that affect the business' future needs.

3. The method of claim 1, wherein a matrix displays the locations of each of the departments relative to each other based upon selections made by the user in the computerized space programming program.

4. The method of claim 2, further comprising the step of determining if the real-time overview is accurate and if any employees should be transferred into or out of a particular department.

5. The method of claim 4, further comprising the step of adding new employees, consultants or temps who require space.

6. The method of claim 5, further comprising the step of viewing sample office standards and confirming assignments to each employee.

7. The method of claim 1, wherein the data to be gathered are selected from a list consisting of the number of employees, location of current employees, names and titles of current employees and the required square footage need of the current employees workspace.

8. The method of claim 1, wherein the data is analyzed objectively creating various strategic options that are available to the company.

9. The method of claim 1, wherein the data gathered is analyzed by looking at databases of information, comparing the gathered data to previous data, researching and looking at industry benchmarks.

10. The method of claim 1, wherein forecasting comprising the steps of:
Validating the current employees for a department;
Projecting headcount growth;
Validating current support spaces for a department; and
Projecting future growth space.

11. The method of claim 1, wherein the each of the departments is selected from the group consisting of human resources, administration, technical sales support, software consulting, customer care and engineering.

12. The method of claim 1, wherein determining the location of each of the departments of the business in relation to each other is a three step process: (1) identifying critical adjacency needs of one department to other departments; (2) resolving any discrepancies between the stated adjacency needs and those stated by the other departments; and (3) identifying the adjacency needs of the user's department(s) to specific support spaces.

13. The method of claim 1, wherein during the web interview, the user is asked to provide qualitative information about a department's current and future needs, goals and issues.

14. The method of claim 1, wherein the computerized space programming method generates different reports indicating space programming options available to the business based upon the data enter by the user.

15. The method of claim 1, wherein the space programming of a business takes into consideration short-term and long-term requirements.

16. The method of claim 1, to print reports of the forecast of the space programming.

17. The method of claim 1, wherein the computerized space Programming program summarizes the business's' space related data.

18. The method of claim 1, wherein when the user looks at the reports, the user looks at definitions, budget, advantages and disadvantages of each report and the schedule or time line involved in implementing each of the various reports to determine which report best suits the business.

19. The method of claim 1, wherein a person with fewer privileges can perform the validation part of the space programming for the each of the departments so that management will only have to complete strategic information in other parts of the program.
